(19) United States
(12) Patent Application Publication
(10) Pub. No.: US 2026/0360151 A1
(43) Pub. Date: Nov. 12, 2026

(54) Electronic Devices and Corresponding Methods for Context-Aware Restricted Area Control of Wearable Sensor Devices

(71) Applicant: Motorola Mobility LLC, Chicago, IL (US)

(72) Inventors: Ioannis A Zigras, Chicago, IL (US); Ranjeet Gupta, Aurora, IL (US)

(21) Appl. No.: 19/232,531

(22) Filed: Jun. 9, 2025

(30) Foreign Application Priority Data
May 8, 2025 (GR) 20250100340

(51) Int. Cl. G06V 20/52; G06V 20/40

(52) U.S. Cl. CPC G06V 20/52; G06V 20/44

(57) ABSTRACT

An electronic device includes an image capture device operable to capture image sensor data of an environment of the electronic device and one or more processors. The one or more processors are configured to analyze the image sensor data using an artificial intelligence model trained to classify restricted area characteristics indicative of a photography prohibited environment. In response to restricted area classifications from the image capture device indicating the photography prohibitive environment, the one or more processors execute one or more restricted area operations, examples of which include disabling the image capture device and/or discarding image data captured from the photography prohibitive environment from a memory of the electronic device.

### CROSS REFERENCE TO PRIOR APPLICATIONS

This application claims priority and benefit under 35 U.S.C. §119 from Greek Patent Application No. 20250100340, filed May 8, 2025, which is incorporated by reference by rule in accordance with 37 CFR §1.57.

### BACKGROUND

### Technical Field

This disclosure relates generally to electronic devices, and more particularly to electronic devices having sensors for monitoring an environment about the electronic device.

### Background Art

The technology associated with wearable sensor devices has been rapidly evolving, much like the continuous advancements observed in portable electronic systems. Illustrating by example, while early wearable devices offered only rudimentary functionalities with limited sensor integration, modern wearable devices now incorporate a wide array of sensors combined with compact designs.

While these enhanced wearable devices are capable of capturing high-resolution information and processing complex environmental data, they still often function in predetermined modes. In many instances, such systems rely on fixed operational thresholds that require manual intervention to manage intricate situational demands. In scenarios where discretion is of great importance, the built-in rigidity of these conventional approaches not only leads to operational inefficiencies but also raises heightened privacy-related concerns. It would be advantageous to have improved wearable electronic devices that operate more seamlessly without this requisite manual intervention.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present disclosure.

FIG. 1 illustrates one explanatory electronic device in accordance with one or more embodiments of the disclosure.

FIG. 2 illustrates one explanatory system in accordance with one or more embodiments of the disclosure.

FIG. 3 illustrates one explanatory method in accordance with one or more embodiments of the disclosure.

FIG. 4 illustrates one or more explanatory method steps in accordance with one or more embodiments of the disclosure.

FIG. 5 illustrates one or more explanatory method steps in accordance with one or more embodiments of the disclosure.

FIG. 6 illustrates one or more explanatory method steps in accordance with one or more embodiments of the disclosure.

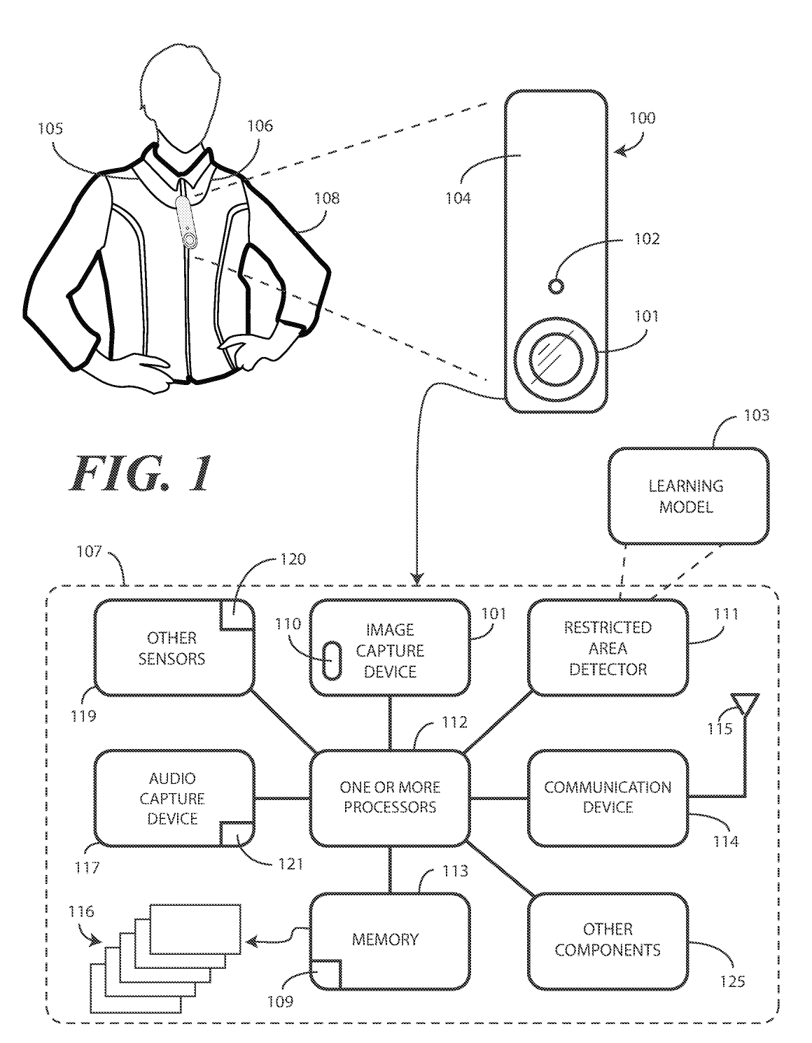

FIG. 1 illustrates another explanatory method in accordance with one or more embodiments of the disclosure.

FIG. 8 illustrates one or more embodiments of the disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION OF THE DRAWINGS

Before describing in detail embodiments that are in accordance with the present disclosure, it should be observed that the embodiments reside primarily in combinations of method steps and apparatus components related to receiving, by one or more processors, image sensor data from an image capture device, analyzing, by the one or more processors, the image sensor data to identify restricted area characteristics depicted in the image sensor data, and responsive to identifying the restricted area characteristics depicted in the image sensor data, performing one or more restricted area operations. Any process descriptions or blocks in flow charts should be understood as representing modules, segments, or portions of code which include one or more executable instructions for implementing specific logical functions or steps in the process.

Alternate implementations are included, and it will be clear that functions may be executed out of order from that shown or discussed, including substantially concurrently or in reverse order, depending on the functionality involved. Accordingly, the apparatus components and method steps have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

Embodiments of the disclosure do not recite the implementation of any commonplace business method aimed at processing business information, nor do they apply a known business process to the particular technological environment of the Internet. Moreover, embodiments of the disclosure do not create or alter contractual relations using generic computer functions and conventional network operations. Quite to the contrary, embodiments of the disclosure employ methods that, when applied to electronic device and/or user interface technology, improve the functioning of the electronic device itself by and improving the overall user experience to overcome problems specifically arising in the realm of the technology associated with electronic device user interaction.

It will be appreciated that embodiments of the disclosure described herein may be comprised of one or more conventional processors and unique stored program instructions that control the one or more processors to implement, in conjunction with certain non-processor circuits, some, most, or all of the functions of using one or more processors to analyze the image sensor data using an artificial intelligence (AI) model trained to classify restricted area characteristics indicative of a photography prohibited environment and, in response to restricted area classifications from the image capture device indicating the photography prohibitive environment, execute one or more restricted area operations as described herein. The non-processor circuits may include, but are not limited to, a radio receiver, a radio transmitter, signal drivers, clock circuits, power source circuits, and user input devices.

As such, these functions may be interpreted as steps of a method to perform receiving, by one or more processors, one or more image frames and corresponding audio samples from the electronic device, analyzing, by the one or more processors using an on-device artificial intelligence model trained to classify restricted, private, or government-designated areas, the one or more image frames and correlating analysis with the corresponding audio samples to generate a privacy classification determination, and discarding, by the one or more processors, a set of image frames from a rolling buffer in response to the privacy classification determination indicating a presence of a restricted or private area. Alternatively, some or all functions could be implemented by a state machine that has no stored program instructions, or in one or more application specific integrated circuits (ASICs), in which each function or some combinations of certain of the functions are implemented as custom logic.

Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ASICs with minimal experimentation.

Embodiments of the disclosure are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions.

As used herein, components may be “operatively coupled” when information can be sent between such components, even though there may be one or more intermediate or intervening components between, or along the connection path. The terms “substantially,” “essentially,” “approximately,” “about,” or any other version thereof, are defined as being close to as understood by one of ordinary skill in the art, and in one non-limiting embodiment the term is defined to be within ten percent, in another embodiment within five percent, in another embodiment within one percent and in another embodiment within one-half percent.

The term “coupled” as used herein is defined as connected, although not necessarily directly and not necessarily mechanically. Also, reference designators shown herein in parenthesis indicate components shown in a figure other than the one in discussion. For example, talking about a device (10) while discussing figure A would refer to an element, 10, shown in figure other than figure A.

As noted above, wearable sensor devices have seen significant advancements, paralleling the rapid evolution of portable electronic systems. Initially, these devices offered basic functionalities with minimal sensor integration. However, modern wearable devices now boast a multitude of sensors within compact designs, enabling a range of context-aware applications that were once unimaginable.

In recent years, the proliferation of wearable sensor devices has transformed the landscape of personal electronics, offering users unprecedented capabilities to capture and interact with their environment. These devices, often equipped with cameras and other sensors, have become essential for documenting daily life, enhancing personal security, and facilitating professional tasks. To illustrate, embodiments of the disclosure contemplate that a person may choose to wear a wearable camera that continually captures images of their environment for several reasons that draw interest.

First, such a device offers the ability to document daily life experiences effortlessly, providing a visual diary that can be revisited to relive moments or share them with others. This can be particularly beneficial for individuals who wish to capture spontaneous events or fleeting interactions that might otherwise be forgotten.

Additionally, wearable cameras can enhance personal security by recording surroundings, which can be useful in providing evidence in case of incidents or disputes. For professionals, such as journalists or researchers, wearable cameras serve as an effective tool for gathering information unobtrusively, allowing them to focus on their tasks without the distraction of manually operating a camera.

Furthermore, wearable cameras can be integrated with advanced technologies, such as artificial intelligence, to provide real-time analysis and insights, augmenting the user's understanding of their environment. These benefits collectively motivate individuals to purchase and wear wearable cameras, attaching them to their clothing or wearing them around their necks for convenience and accessibility.

Despite these advancements in the technology and the personal motivations that make wearing an “always ON” camera socially acceptable, many wearable devices still operate in fixed modes, relying on predetermined thresholds that necessitate manual adjustments to meet complex situational needs. Embodiments of the disclosure contemplate that this rigidity can lead to inefficiencies and privacy concerns, particularly in environments where discretion is paramount.

Indeed, the widespread adoption of such technology has also introduced significant privacy concerns, particularly in environments where discretion is crucial. Users frequently encounter situations where recording is either legally restricted or socially unacceptable, such as in hospitals, government facilities, and private residences. The challenge lies in ensuring that these devices can adapt to varying privacy requirements without compromising their functionality or user experience.

To illustrate, consider the case of Sarah, a journalist who frequently attends confidential meetings. She relies on her wearable device to capture notes and record interviews. However, during a sensitive meeting at a government facility, her device inadvertently captures restricted information due to its inability to recognize the environment's privacy requirements. This not only compromises her work but also raises significant privacy issues.

In another scenario, John, a healthcare professional, uses a wearable device to monitor patient interactions in a hospital setting. The device is designed to record patient data for analysis. However, when John enters a restricted area where recording is prohibited, the device fails to adjust its settings automatically, leading to potential breaches of patient confidentiality and legal complications.

These examples highlight the challenges faced by users who need their devices to adapt swiftly to changing environments. The integration of multiple sensor modalities within a single device has introduced complexities in context detection and user interaction. Often, adjusting system states to align with environmental cues requires cumbersome steps, delaying timely responses.

Advantageously, embodiments of the disclosure provide an improved approach that balances operational performance with dynamic privacy considerations is essential to enhance user experience and system effectiveness in sensitive contexts. In one or more embodiments, a method and system address these challenges by introducing an advanced approach for context-aware restricted area control of wearable sensor devices.

In one or more embodiments, this approach leverages an on-device artificial intelligence model trained to classify restricted, private, or government-designated areas, enabling the device to automatically adjust recording capabilities in response to environmental cues. By analyzing image and audio data in real-time, the system can identify indicators of private areas and execute appropriate operations, such as disabling the camera or discarding sensitive data. Advantageously, this strategy not only enhances the privacy and security of the user but also improves the overall functionality and adaptability of the wearable device, providing a seamless and intuitive user experience.

In one or more embodiments, a method implemented in an electronic device involves receiving image sensor data from an image capture device and analyzing this data to identify characteristics indicative of restricted areas. In one or more embodiments, the method utilizes one or more processors to perform the analysis, leveraging an artificial intelligence model trained to classify environments where recording is prohibited, such as private or government-designated areas.

In one or more embodiments, upon identifying these restricted area characteristics, the method executes one or more operations designed to address privacy concerns, such as disabling the image capture device or deleting the image sensor data from the device's memory. Advantageously, this approach ensures that the electronic device adapts to varying privacy requirements dynamically, enhancing user security and compliance with legal and social norms regarding privacy in sensitive environments.

In one or more embodiments, the operational principle of this method relies on combining image sensor data analysis with restricted area detection, enabling the device to automatically adjust its functionality according to the environment. This setup ensures that the device can identify and respond to privacy-sensitive areas without needing manual intervention from the user. By automating the detection and response process, the method enhances user privacy and compliance with legal and social norms, particularly in environments where discretion is important, such as hospitals, government facilities, and private residences.

Compared to existing solutions that rely on fixed operational thresholds or manual adjustments, this method offers a more seamless and efficient way to manage privacy concerns. The use of image sensor data analysis enables real-time detection of restricted areas, allowing the device to promptly execute operations such as disabling the camera or deleting sensitive data. This approach not only improves the functionality and adaptability of the wearable device but also provides a practical solution to the challenges faced by users in privacy-sensitive contexts.

The method's implementation can be illustrated through scenarios where the device automatically detects restricted areas and performs operations to prevent unauthorized recording. For example, when a user enters a government facility, the device can identify the environment's privacy requirements and disable the camera, thereby preventing the capture of restricted information. This capability enhances the overall user experience by ensuring that the device operates in accordance with privacy regulations without compromising functionality.

In short, embodiments of the disclosure provide solutions for enhancing privacy in wearable camera devices. In one or more embodiments, these solutions involve a multi-step process that leverages an on-device artificial intelligence model to classify environments where recording is prohibited.

Initially, in one or more embodiments the AI model analyzes the camera preview to detect restricted or private areas, such as bathrooms or government facilities, by identifying specific visual and audio cues. Upon detection, in one or more embodiments the system alerts the user through audio or visual notifications, signaling the need for action.

Concurrently, the device optionally discards any frames captured in these restricted zones, ensuring that no private data is recorded or leaked. In one or more embodiments, the camera is reactivated only after significant displacement from the restricted area, allowing seamless operation without user intervention. Advantageously, this approach effectively mitigates privacy vulnerabilities by automatically managing device operations in sensitive environments, thereby enhancing user security and compliance with legal and social norms.

In one or more embodiments, an electronic device comprises an image capture device configured to capture image sensor data of the environment surrounding the electronic device. In one or more embodiments, the device includes one or more processors that are programmed to analyze this image sensor data using an artificial intelligence model specifically trained to classify characteristics indicative of a photography-prohibited environment.

In one or more embodiments, upon receiving classifications from the image capture device that indicate the presence of such an environment, the processors are further configured to execute one or more restricted area operations. These operations may include, but are not limited to, disabling the image capture device, deleting image data from memory, or alerting the user to the presence of a restricted area. Advantageously, this configuration ensures that the electronic device dynamically adapts to privacy requirements, thereby enhancing user security and compliance with legal and social norms in sensitive environments

Moreover, this configuration advantageously enables the electronic device to adjust to privacy requirements by automatically identifying environments where photography is prohibited and executing operations to prevent unauthorized recording. The integration of an AI model facilitates real-time analysis of image data, ensuring that the device can promptly respond to privacy-sensitive areas without manual intervention. This setup improves user security and compliance with legal and social norms, particularly in environments where discretion is important, such as hospitals, government facilities, and private residences.

The operational principle of using an AI model for classification also provides a novel approach compared to existing solutions that rely on fixed operational thresholds or manual adjustments. By automating the detection and response process, the device improves functionality and adaptability, offering a seamless and efficient way to manage privacy concerns. This method ensures that the device operates in accordance with privacy regulations without compromising the device's functionality, thereby enhancing the overall user experience.

In one or more embodiments, a method involves receiving, by one or more processors, one or more image frames and corresponding audio samples from the electronic device. In one or more embodiments, the processors analyze these image frames using an on-device artificial intelligence model specifically trained to classify restricted, private, or government-designated areas.

In one or more embodiments, this analysis is correlated with the corresponding audio samples to generate a privacy classification determination. Upon determining the presence of a restricted or private area, the processors discard a set of image frames from a rolling buffer. Advantageously, this approach ensures that potentially sensitive or prohibited content is not retained, thereby enhancing user privacy and compliance with legal and social norms. The method provides a seamless and automated solution to managing privacy concerns, allowing the device to adapt dynamically to the surrounding environment without requiring manual intervention from the user.

In sum, this method provides a practical application by ensuring that sensitive or prohibited content is not retained, thereby enhancing user privacy and compliance with legal and social norms. The integration of both image and audio data allows for a more robust and accurate classification of restricted areas, reducing the likelihood of false positives or negatives. By utilizing an on-device AI model, the method ensures low latency and improved privacy, as data does not need to be transmitted to external servers for processing.

This approach not only automates the privacy management process but also minimizes user intervention, offering a seamless user experience while maintaining the functionality of the device in privacy-sensitive environments. Other advantages will be described below. Still others will be obvious to those of ordinary skill in the art having the benefit of this disclosure.

Turning now to FIG. 1, illustrated therein is one explanatory electronic device 100 configured in accordance with one or more embodiments of the disclosure. In one or more embodiments, the electronic device 100 includes a wearable sensor arrangement comprising one or more sensors 119 that designed to address privacy concerns in restricted areas.

In one or more embodiments, the one or more sensors 119 comprise an image capture device 101 and a microphone 102 that serves as an audio capture device 117. In one or more embodiments, the microphone 102 and image capture device 101 are each in electronic communication with one or more processors 112. In one or more embodiments, the image capture device 101 of the electronic device 100 acquires image sensor data, and one or more processors utilize a restricted area detector 111 that is trained with an artificial intelligence (AI) based learning model to analyze the image sensor data to identify characteristics associated with restricted areas.

In one or more embodiments upon detection of such restricted area characteristics, the one or more processors 112 perform one or more operations such as disabling the image capture device 101 or deleting data from a memory 113 of the electronic device 100. In one or more embodiments, in response to environmental stimuli indicating a hospital or government facility setting, the one or more processors 112 transition to a privacy-enhanced mode of operation where selected functions are precluded to ensure compliance with legal norms.

As a result, the electronic device 100 advantageously enhances privacy by dynamically adapting to the surrounding environment. By automatically disabling the image capture device 101 in sensitive areas, the electronic device 100 provides a seamless user experience without manual intervention.

In this explanatory embodiment, the electronic device 100 is configured as a wearable electronic device. This illustrative wearable electronic device has a housing 104. In some embodiments, the electronic device 100 can also include and one or more straps 105,106 that allow the wearable electronic device to be worn around a user’s neck. In other embodiments, the electronic device 100 can be worn as a brooch by being clipped to a garment.

While a necklace or brooch is one embodiment of a wearable electronic device configured in accordance with one or more embodiments of the disclosure, other types of wearable electronic devices and/or other mechanical configurations of wearable electronic devices will be obvious to those of ordinary skill in the art having the benefit of this disclosure. Illustrating by example, in other embodiments the electronic device 100 could be configured as a headband or smartwatch.

Also illustrated in FIG. 1 is one explanatory block diagram schematic 107 of the wearable electronic device. It should be noted that the block diagram schematic of FIG. 1 includes many components that are optional, but which are included in an effort to demonstrate how varied electronic devices configured in accordance with embodiments of the disclosure can be. Accordingly, it is to be understood that the block diagram schematic of FIG. 1 is provided for illustrative purposes only and for illustrating components of one wearable electronic device in accordance with embodiments of the disclosure. The block diagram schematic of FIG. 1 is not intended to be a complete schematic diagram of the various components required for a wearable electronic device.

Therefore, other wearable electronic devices in accordance with embodiments of the disclosure may include various other components not shown in FIG. 1 or may include a combination of two or more components or a division of a particular component into two or more separate components and §still be within the scope of the present disclosure. A wearable electronic device may have fewer, or different, components from another wearable electronic device configured in accordance with embodiments of the disclosure. Accordingly, wearable electronic devices configured in accordance with embodiments of the disclosure can include some components that are not shown in FIG. 1, and other components that are shown may not be needed and can therefore be omitted.

This illustrative wearable electronic device can include an optional display, which in one embodiment is touch-sensitive and defines a user interface for the wearable electronic device. In the illustrative embodiment of FIG. 1, the electronic device 100 is a dedicated “data capture” device that is devoid of a display. Where a display is included, users may be able deliver user input to the display of such an embodiment by delivering touch input from a finger, stylus, or other objects disposed proximately with the display.

Features can be incorporated into the housing 104. Illustrating by example, a biometric sensor might be disposed along a surface of the housing 104 so that a user 108 of the electronic device 100 can be authenticated. Where included, the biometric sensor can be responsible for identifying biometric input received at the biometric sensor to authenticate or otherwise identify the user 108 as an authorized user of the wearable electronic device. Other devices can be disposed along the housing 104 as well. Examples of such devices include a speaker port for an audio output device.

The image capture device 101 can include one or more components. For example, in one or more embodiments the image capture device 101 comprises and one or more of an image sensor, a depth imager, and, optionally, one or more proximity sensors.

In one embodiment, the image capture device 101 comprises a two-dimensional imager configured to receive at least one image of an environment about the wearable electronic device. In one embodiment, the image capture device 101 comprises a two-dimensional Red-Green-Blue (RGB) imager. In another embodiment, the image capture device 101 comprises an infrared imager. Other types of imagers suitable for use as the image capture device 101 of wearable electronic device will be obvious to those of ordinary skill in the art having the benefit of this disclosure.

The one or more proximity sensors, where included, can take various forms. In one or more embodiments, the one or more proximity sensors fall into one of two camps: active proximity sensors and “passive” proximity sensors. Either the proximity detector components or the proximity sensor components can be generally used for detecting persons and/or present within the environment, distances between warm objects and the wearable electronic device, changes in distance between warm objects and the wearable electronic device, and other information. Accordingly, in one or more embodiments the one or more proximity sensors can be used as a “wearability” detector by detecting the wearable electronic device being proximately located and worn by an authorized user.

As used herein, a “proximity sensor component” comprises a signal receiver only that does not include a corresponding transmitter to emit signals for reflection off an object to the signal receiver. A signal receiver only can be used due to the fact that a user’s body or other heat generating object external to the wearable electronic device serves as the transmitter. In one embodiment, the signal receiver is an infrared signal receiver to receive an infrared emission from a source, such as a human being, when the human being is approaching the wearable electronic device.

Proximity sensor components are sometimes referred to as a “passive IR detectors” due to the fact that the person is the active transmitter. Accordingly, the proximity sensor component requires no transmitter since objects disposed external to the housing deliver emissions that are received by the infrared receiver. As no transmitter is required, each proximity sensor component can operate at a very low power level.

By contrast, proximity detector components include a signal emitter and a corresponding signal receiver, which constitute an “active IR” pair. While each proximity detector component can be any one of various types of proximity sensors, such as but not limited to, capacitive, magnetic, inductive, optical/photoelectric, imager, laser, acoustic/sonic, radar-based, Doppler-based, thermal, and radiation-based proximity sensors, in one or more embodiments the proximity detector components comprise infrared transmitters and receivers.

In one or more embodiments, each proximity detector component can be an infrared proximity sensor set that uses a signal emitter that transmits a beam of infrared light that reflects from a nearby object and is received by a corresponding signal receiver. Proximity detector components can be used, for example, to compute the distance to any nearby object from characteristics associated with the reflected signals. The reflected signals are detected by the corresponding signal receiver, which may be an infrared photodiode used to detect reflected light emitting diode (LED) light, respond to modulated infrared signals, and/or perform triangulation of received infrared signals.

In one embodiment, the one or more proximity sensors simply comprise a proximity sensor component. In another embodiment, the one or more proximity sensors comprise a simple thermopile. In another embodiment, the one or more proximity sensors comprise an infrared imager that captures the amount of thermal energy emitted by an object. In still other embodiments, the one or more proximity sensors comprise a proximity detector component. Of course, combinations of these components can be used as the one or more proximity sensors. Moreover, other types of proximity sensors suitable for use with the wearable electronic device will be obvious to those of ordinary skill in the art having the benefit of this disclosure.

As with the one or more proximity sensors, the depth imager, where included, can take a variety of forms. In a first embodiment, the depth imager comprises a pair of imagers separated by a predetermined distance, such as three to four images. This “stereo” imager works in the same way the human eyes do in that it captures images from two different angles and reconciles the two to determine distance.

In another embodiment, the depth imager employs a structured light laser. The structured light laser projects tiny light patterns that expand with distance. These patterns land on a surface, such as a user’s face, and are then captured by an imager. By determining the location and spacing between the elements of the pattern, three-dimensional mapping can be obtained.

In still another embodiment, the depth imager comprises a time-of-flight device. Time of flight three-dimensional sensors emit laser or infrared pulses from a photodiode array. These pulses reflect back from a surface, such as the user’s face. The time it takes for pulses to move from the photodiode array to the surface and back determines distance, from which a three-dimensional mapping of a surface can be obtained. Regardless of embodiment, the depth imager adds a third “z-dimension” to the x-dimension and y-dimension defining the two-dimensional image captured by the image capture device 101, thereby enhancing the accuracy of detecting persons being present within the environment.

In one or more embodiments, the image capture device 101 includes a plurality of photosensitive elements that receive light from the environment of the electronic device 100 and generate electronic signals indicating characteristics of the received light, such as intensity, wavelength, and so forth. In one or more embodiments, the electronic signals from the photosensitive elements are used by the electronic device 100 to assign values (e.g., color or grayscale values) to pixels in pixel data associated with the digital images.

In one or more embodiments, the image capture device 101 can acquire image data in various modes. Such modes may include, for example, a continuous imaging mode and a shuttered mode.

In the continuous imaging mode, the image capture device 101 continuously acquires preview image data in real-time and without interruption. For example, while in the continuous imaging mode, the image capture device 101 generates preview image frames continuously at a pre-determined rate or a rate specified by a user of the electronic device 100 via user input. These preview image frames can be stored in the rolling buffer 109 of the memory 113.

The rate of preview image frame generation may be, for example, fifteen preview image frames per second, thirty preview image frames per second, sixty preview image frames per second, etc. Therefore, while operating in the continuous imaging mode, the preview image data generated by the image capture device 101 can include a plurality of preview image frames generated over a span of time (e.g., a duration of operating in the continuous imaging mode). In some instances, the preview image data may be formatted as video data.

In the shuttered mode, the image capture device 101 is operable to acquire individual preview image frames or a series of preview image frames including a pre-defined number of preview image frames responsive to input received by the electronic device 100. The input may include, for example, user input applied via one or more physical buttons of the electronic device 100, touchscreen input, and so forth.

In some implementations, the image capture device 101 may default to operating in the continuous imaging mode following power-on of the electronic device 100. Power-on of the electronic device 100 includes, for example, adjustment of the electronic device 100 from an “off” condition in which the electronic device 100 is inactive and not processing data, to an “on” condition in which the electronic device 100 is active and employing resources supporting operation of the operating system, applications, and so forth.

As one example, the electronic device 100 may be configured to be worn by a user (e.g., as a necklace or brooch or other type of worn device) and may operate with the image capture device 101 in the continuous imaging mode until receiving user input to deactivate the continuous imaging mode (e.g., user input to turn off the image capture device 101 or adjust the image capture device 101 to a different operating mode such as the shuttered mode). The user input may include, for instance, touch applied to one or more physical buttons of the electronic device 100, selection of one or more graphical user interface elements displayed by the display, and so forth.

In one or more embodiments, the image capture device 101 can be operable with a restricted area detector 111. In one or more embodiments, the restricted area detector 111 can be configured to process an image or depth scan of an object and determine whether the object matches predetermined criteria by comparing the image or depth scan to one or more predefined authentication references stored in memory 113.

For example, the restricted area detector 111 can identify whether one or more persons or objects are within an environment of the wearable electronic device in one or more embodiments. Additionally, by comparing the images and/or depth scans to the predefined authentication references, in one or more embodiments the restricted area detector 111 can identify the objects within the environment. In one or more embodiments the restricted area detector 111 can employ optical and/or spatial recognition to identify persons or objects using image recognition, character recognition, visible recognition, facial recognition, color recognition, shape recognition, and the like.

In one or more embodiments, the restricted area detector 111 is configured to analyze the image sensor data using an artificial intelligence model 103 trained to classify restricted area characteristics indicative of a photography prohibited environment. In one or more embodiments, the restricted area detector 111 is a component of a wearable electronic device that utilizes an artificial intelligence (AI) model 103 to identify locations where taking photos or videos is prohibited. This function is significant for maintaining privacy in sensitive areas such as hospitals, government buildings, or private homes.

In one or more embodiments, when the image capture device 101 captures image sensor data, this image sensor data is delivered to the restricted area detector 111. In one or more embodiments, this image sensor data is then analyzed by the AI model 103. In one or more embodiments, the AI model 103 has been trained to recognize specific features or signs that indicate a restricted area. For example, the AI model 103 might look for signs that say “No Photography” or recognize the interior of a hospital room.

In one or more embodiments, the AI model 103 is trained only on restricted area data. Advantageously, this makes the AI model 103 very quick and light so that quick responses can be obtained when items such as church pews, medical equipment, copyrighted material, bathroom fixtures, hospital signs, and so forth are detected.

In some embodiments, the restricted area detector 111 can also analyze sounds when electrical signals corresponding to those sounds are received from the microphone 102. For instance, the restricted area detector 111 might listen for announcements or specific noises that are typical in restricted areas, such as the sound of medical equipment in a hospital.

In one or more embodiments, the AI model 103 can utilize both image and audio data in conjunction to make a more precise determination. This approach allows the model to cross-reference visual information with auditory input to assess whether the area is restricted.

In one or more embodiments. the AI model 103 is stored and operates directly on the electronic device 100. This approach eliminates the need to send data to the cloud for processing, which helps protect user privacy and accelerates the detection process.

In some embodiments, the image sensor data received from the image capture device 101 is stored temporarily in a rolling buffer 109 located in the memory 113. In one or more embodiments, if the restricted area detector 111 detects a restricted area, the system can delete these images to ensure no sensitive data is saved.

In some embodiments, when a restricted area is detected, the restricted area detector 111 can alert the user 108. This might be through a vibration, a sound, or a notification on a connected device, like a smartphone.

Consider some use cases: In one or more embodiments, the restricted area detector 111 can detect when a user enters a hospital and automatically stop recording to protect patient privacy. In other situations, the device identifies the interior of a government building, the device can disable the camera to prevent unauthorized recording. In still other situations, the restricted area detector 111 can identify when the user is in a private home and ensure that no images are captured without permission. In still other situations, the restricted area detector 111 can recognize signs that prohibit photography and respond accordingly by stopping the camera. By using these methods, the restricted area detector 111 helps ensure that the wearable device respects privacy and legal restrictions, providing a seamless experience for the user without needing manual intervention.

In one or more embodiments, the restricted area detector 111, in response to restricted area classifications from the image capture device indicating the photography prohibitive environment, can utilize the one or more processors 112 execute one or more restricted area operations. In the context of the electronic device 100, operations within restricted areas are important for ensuring privacy and compliance with legal and social norms.

The one or more restricted area operations can take various forms. Illustrating by example, these operations can include delivering an alert, deleting image sensor data, deactivating the image capture device, and masking portions of the image sensor data.

For instance, when a user enters a restricted area such as a hospital, the electronic device 100 can deliver an alert through vibrations or audible notifications, prompting the user 108 to take action, which is beneficial for immediate awareness and compliance. Deleting image sensor data ensures that no sensitive information is retained, protecting both the user and the privacy of others. This can be achieved through a rolling buffer 109 that automatically discards frames, providing a seamless and automated privacy solution.

Deactivating the image capture device 101 prevents further recording, which can be implemented by disabling the camera hardware or software, ensuring that no data is captured in sensitive environments. Masking portions of the image sensor data can obfuscate sensitive information, allowing the device to continue functioning while respecting privacy constraints. This can be done through software algorithms that blur or pixelate specific areas of the image, maintaining the device's utility while safeguarding privacy. Each method offers distinct advantages, such as real-time responsiveness, data security, and user convenience, enhancing the overall functionality and adaptability of the wearable device in privacy-sensitive contexts.

The wearable electronic device includes one or more processors 112. The one or more processors 112 can be operable with the various components of the wearable electronic device. The one or more processors 112 can be configured to process and execute executable software code to perform the various functions of the wearable electronic device. A storage device, such as memory 113, can optionally store the executable software code used by the one or more processors 112 during operation.

The wearable electronic device also includes a wireless communication device 114. The wireless communication device 114 can be configured for wired or wireless communication with one or more other devices or networks. The networks can include a wide area network, a local area network, and/or personal area network. The wireless communication device 114 may also utilize wireless technology for communication, such as, but are not limited to, peer-to-peer or ad hoc communications such as HomeRF, Bluetooth.sup.TM and IEEE 802.11 (a, b, g or n); and other forms of wireless communication such as infrared technology. The wireless communication device 114 can include wireless communication circuitry, one of a receiver, a transmitter, or transceiver, and one or more antennas 115.

In one or more embodiments, the wearable electronic device includes other components 125, one example of which is an audio input/processor. The audio input/processor is operable to receive audio input from a source, such as a person, authorized user, plurality of persons within an environment about the wearable electronic device, from the environment about the wearable electronic device, or combinations thereof. The audio input/processor can include hardware, executable code, and speech monitor executable code in one embodiment. The audio input/processor can be operable with one or more predefined authentication references stored in memory 113.

The predefined authentication references can comprise representations of basic speech models, representations of trained speech models, or other representations of predefined audio sequences that are used by the audio input/processor to receive and identify speech captured by an audio capture device 117, one example of which are the one or more microphones 102 carried by the housing 104 of the electronic device 100. In one embodiment, the audio capture device 117 can include a voice interface engine. Regardless of the specific implementation utilized in the various embodiments, the audio capture device 117 can access various speech models stored with the predefined authentication references to identify speech commands in one or more embodiments.

The audio capture device 117 can include a beam steering engine. The beam steering engine can be operable with one or both of an audio input device, such as one or more microphones 102, and/or an audio output device, such as one or more loudspeakers. When functioning with the audio capture device 117, the beam steering engine can process audio input from, for example, one or more microphones 102 defining a virtual microphone. This virtual microphone can define an acoustic reception cone that can be virtually “steered” around the wearable electronic device. Alternatively, actual steering can occur as well, such as switching between a left microphone and right microphone or a front and back microphone or switching various microphones ON and OFF individually. In one or more embodiments, two or more microphones can be included for selective beam steering by the beam steering engine.

Various sensors 119 can be operable with the one or more processors 112. A first example of a sensor that can be included with the various sensors 119 is a touch sensor. The touch sensor can include a capacitive touch sensor, an infrared touch sensor, resistive touch sensors, or another touch-sensitive technology. The touch sensor can be configured to detect an object in close proximity with – or touching – the surface of the display 702 or the housing 104 of the wearable electronic device.

Another example of a sensor 119 is a geo-locator that serves as a location detector 120. In one embodiment, location detector 120 is able to determine location data. Location can be determined by capturing the location data from a constellation of one or more earth orbiting satellites, or from a network of terrestrial base stations to determine an approximate location. The location detector 120 may also be able to determine location by locating or triangulating terrestrial base stations of a traditional cellular network, such as a CDMA network or GSM network, or from other local area networks, such as Wi-Fi networks.

One or more motion detectors can be configured as an orientation detector that determines an orientation and/or movement of the wearable electronic device in three-dimensional space. Illustrating by example, the orientation detector can include an accelerometer, gyroscopes, or other device to detect device orientation and/or motion of the wearable electronic device. Using an accelerometer as an example, an accelerometer can be included to detect motion of the electronic device. Additionally, the accelerometer can be used to sense some of the gestures of the user, such as one talking with their hands, running, or walking.

The orientation detector can determine the spatial orientation of the wearable electronic device in three-dimensional space by, for example, detecting a gravitational direction. In addition to, or instead of, an accelerometer, an electronic compass can be included to detect the spatial orientation of the electronic device relative to the earth’s magnetic field. Similarly, one or more gyroscopes can be included to detect rotational orientation of the wearable electronic device.

Other components 125 operable with the one or more processors 112 can include output components such as video, audio, and/or mechanical outputs. For example, the output components may include a video output component or auxiliary devices including a cathode ray tube, liquid crystal display, plasma display, incandescent light, fluorescent light, front or rear projection display, and light emitting diode indicator. Other examples of output components include audio output components such as the one or more loudspeakers 729, ultrasound transducers, or other alarms and/or buzzers. The other components 125 can also include a mechanical output component such as vibrating or motion-based mechanisms.

The other components 125 can optionally include a barometer operable to sense changes in air pressure due to elevation changes or differing pressures of the wearable electronic device. The other components 125 can also optionally include a light sensor that detects changes in optical intensity, color, light, or shadow in the environment of the wearable electronic device. An infrared sensor can be used in conjunction with, or in place of, the light sensor. Similarly, a temperature sensor can be configured to monitor temperature about an electronic device.

In one or more embodiments, the one or more processors 112 can define one or more process engines. One example of such a process engine is the restricted area detector 111. The process engines can be a component of the one or more processors 112, operable with the one or more processors 112, defined by the one or more processors 112, and/or integrated into the one or more processors 112. Other configurations for the process engines, including as software or firmware modules operable on the one or more processors 112, will be obvious to those of ordinary skill in the art having the benefit of this disclosure.

The restricted area detector 111 can be operable with the various sensors to detect, infer, capture, and otherwise determine persons and actions that are occurring in the environment about the wearable electronic device. For example, where included one embodiment of the restricted area detector 111 determines assessed contexts and frameworks using adjustable algorithms of context assessment employing information, data, and events. These assessments may be learned through repetitive data analysis and may be assisted by an artificial intelligence (AI) model 103. Alternatively, a user may employ the user interface (where included) of the wearable electronic device to enter various parameters, constructs, rules, and/or paradigms that instruct or otherwise guide the restricted area detector 111 in detecting contextual information to identify restricted area characteristics depicted in image sensor data captured by the image capture device 101. As noted, the restricted area detector 111 can comprise an artificial neural network, an AI model 103, or other similar technology in one or more embodiments.

In one or more embodiments, the restricted area detector 111 is operable with the one or more processors 112. In some embodiments, the one or more processors 112 can control the restricted area detector 111. In other embodiments, the restricted area detector 111 can operate independently, delivering information gleaned from detecting multi-modal social cues, emotional states, moods, and other contextual information to the one or more processors 112. The restricted area detector 111 can receive data from the various sensors. In one or more embodiments, the one or more processors 112 are configured to perform the operations of the restricted area detector 111.

In one or more embodiments, the restricted area detector 111 is configured to analyze image sensor data 110 using the artificial intelligence model 103 trained to classify restricted area characteristics indicative of a photography prohibited environment. In one or more embodiments, the one or more processors 112 are configured, in response to the restricted area detector 111 making restricted area classifications from the image sensor data 110 indicating that the environment in which the electronic device 100 is situated is a photography prohibitive environment, to execute one or more restricted area operations.

Illustrating by example, as noted above the memory 113 can include a rolling buffer 109. In one or more embodiments, the one or more restricted area operations comprise controlling the rolling buffer 109 to temporarily store and selectively discard image frames from the image sensor data depicting the restricted area characteristics. In other embodiments, the one or more restricted area operations can comprise precluding the image capture device 101 from capturing additional image sensor data.

When the electronic device 100 comprises a location detector 120, in one or more embodiments the one or more processors 112 are configured to cause any preclusion of image sensor data capture by the image capture device 101 when the location detector 120 detects a location change of the electronic device 100 by a sufficient amount that it can be concluded that the electronic device 100 has exited the private or restricted photography area. Said differently, when a photography prohibitive environment is detected, in one or more embodiments the one or more processors 112 of FIG. 1 may determine that the electronic device 100 has exited the restricted area when the location detector 120 identifies that the device has moved beyond a predefined distance from the original location where the restricted area classification occurred. This determination is beneficial for ensuring that the electronic device 100 resumes operation only when it is no longer in a sensitive environment.

For instance, in a hospital setting, the electronic device 100 may need to move at least fifty meters to ensure it has left a restricted zone, such as an operating room or patient ward. In a government facility, a movement of one hundred meters might be required to confirm that the device has exited a secure area, such as a conference room or office where sensitive discussions occur. Similarly, in a private residence, the electronic device 100 might need to move 30 meters to ensure it has left a private area, such as a bedroom or bathroom.

These predefined distances are determined based on the typical layout and size of such environments, ensuring that the device only resumes its full functionality when appropriate. Others will be obvious to those of ordinary skill in the art having the benefit of this disclosure. Accordingly, in one or more embodiments the one or more processors 112 are further configured to cease the precluding the capture of image capture device in response to the location detector 120 determining a new location of the electronic device 100 is beyond a previous location of the electronic device 100 where the restricted area classifications occurred.

As noted above, the electronic device 100 can comprise an audio capture device 117 operable to capture audio sensor data 121. In one or more embodiments, the one or more processors 112 are further configured to analyze the audio sensor data 121 using the artificial intelligence model 103. In one or more embodiments, in response to other restricted area classifications from the audio sensor data 121 indicating the photography prohibitive environment, the one or more processors 112 are configured execute the one or more restricted area operations as well.

Combining audio sensor data 121 received from the audio capture device 117 with image sensor data 110 captured by the image capture device 101 can enhance the accuracy and reliability of determining whether the electronic device 100 is in a photography prohibitive environment in some situations. While image sensor data 110 provides visual cues that can indicate restricted areas, such as signs or specific environmental features, audio sensor data 121 adds an additional layer of context by capturing sounds that are characteristic of such environments.

For instance, the presence of announcements, alarms, or specific ambient noises, like the sound of medical equipment in hospitals or religious hymns in places of worship, can corroborate visual indicators, thereby increasing the confidence level of the classification. This multimodal approach reduces the likelihood of false positives or negatives, ensuring that the device responds appropriately to privacy-sensitive areas.

By leveraging both visual and auditory inputs, the electronic device 100 can more accurately assess the surroundings, providing a seamless and automated solution to privacy management without requiring manual intervention from the user 108. Accordingly, in one or more embodiments the one or more processors 112 are further configured to analyze the audio sensor data 121 using the artificial intelligence model 103 and, in response to other restricted area classifications from the audio sensor data 121 indicating the photography prohibitive environment, execute the one or more restricted area operations.

Thus, as shown in FIG. 1, an electronic device 100 configured in accordance with one or more embodiments of the disclosure comprises an artificial intelligence learning model 103, a restricted area detector 111, and one or more processors 112. When these components interact, the electronic device 100 is enabled to perform context-aware restricted area control.

In one or more embodiments, the artificial intelligence learning model 103 plays provides a capability to analyze data and identify restricted area characteristics. In one or more embodiments, the artificial intelligence learning model 103 operates in conjunction with the restricted area detector 111 to process information from the image capture device 101 and, optionally, from the other sensors 119, thereby ensuring that the electronic device 100 can adapt to privacy-sensitive environments.

In one or more embodiments, the artificial intelligence model 103 is trained only with restricted area information. Embodiments of the disclosure contemplate that training the AI model 103 of FIG. 1 with a focus on restricted area information can significantly enhance the model's efficiency and speed in decision-making.

Generally, AI models are trained using large datasets that encompass a wide range of scenarios and features. The training process involves feeding the model with input data and adjusting the model's parameters to minimize the error in predictions. This is a process known as supervised learning.

By concentrating the training dataset on restricted area characteristics, such as visual and auditory cues indicative of privacy-sensitive environments, the AI model 103 can become more specialized and streamlined. This specialization reduces the computational complexity and the size of the model, allowing the model to process data more rapidly and with lower latency.

For instance, in the context of the described system, the AI model 103 can quickly identify environments like hospitals, government facilities, or private residences by recognizing specific indicators such as "No Photography" signs or the presence of medical equipment. This targeted training ensures that the artificial intelligence model 103 is not burdened with extraneous information, thereby enabling the model to execute restricted area operations, such as disabling the image capture device or discarding sensitive data, with greater speed and accuracy. This approach not only enhances the device's responsiveness but also improves user privacy and compliance with legal and social norms in sensitive environments.

Thereafter, the restricted area detector 111 is configured to detect restricted areas by analyzing data received from the image capture device 101. In some embodiments, additional inputs - such as sound – can also be used. In some embodiments, the restricted area detector 111 utilizes the artificial intelligence model 103 to classify environments and determine when to execute restricted area operations, such as disabling the image capture device 101 or alerting the user.

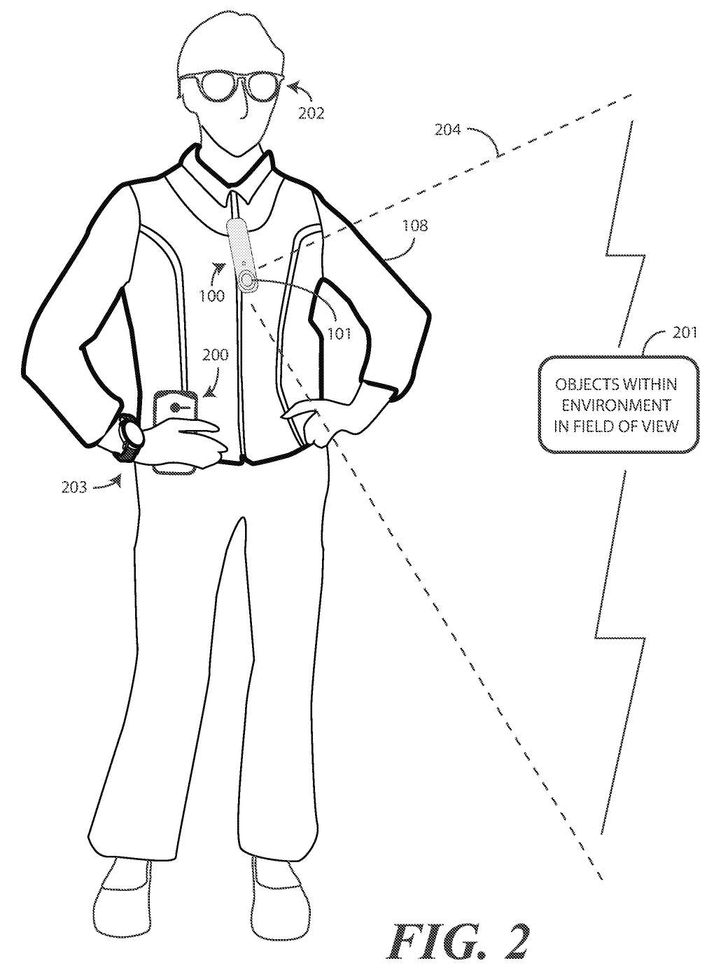

Furthermore, as will be described in more detail with reference to FIG. 2 below, in one or more embodiments communication device 114 is operable to facilitate interaction with external devices and networks. Illustrating by example, in one or more embodiments the electronic device 100 can receive updates or alerts from companion devices, ensuring that connectivity is maintained, and environmental changes can be addressed effectively.

In one or more embodiments, the memory 113 stores data and instructions necessary for the operation of the electronic device 100. For example, the memory 113 may include a rolling buffer 109 that temporarily holds image frames, thereby enabling the device to discard sensitive data upon detection of a restricted area.

In addition, the microphone 102 can capture audio data 121 from the environment of the electronic device 100. When analyzed in conjunction with image sensor data 110 from the image capture device 101, this multimodal approach further enhances the accuracy of restricted area detection, thereby facilitating more informed decisions regarding the device’s operations.

What’s more, in some embodiments the other sensors 119 are included to offer supplementary environmental data, such as motion or proximity information. In one or more embodiments, these sensors contribute to the overall comprehension of the surrounding environment, thus enhancing the context awareness of the electronic device 100.

The one or more sensors 119 can support different input styles from the user 108. Illustrating by example, in one or more embodiments the electronic device 100 supports both gesture-based and non-gesture-based input styles.

The gesture-based input style refers to receiving user inputs that are gestures. These gestures may be applied to a touch-sensitive device, such as a touchscreen or a trackpad (where included). In some implementations, gestures performed within the field of view of the image capture device 101 may be detected and used to control the functionality of the electronic device 100. Gestures can include swipes, touch-and-hold actions, multi-finger swipes or movements, finger or hand movement patterns, combinations thereof, and so forth. The non-gesture-based input style refers to receiving user inputs that are not gestures, such as engagement of one or more buttons (e.g., mouse clicks on a virtual button, pressing a physical button), keyboard keys, and so forth.

The electronic device 100 of FIG. 1 is equipped with a photography prohibitive area detection system, which can be implemented in a variety of different manners. For example, the photography prohibitive area detection system can be realized as multiple instructions stored on computer-readable storage media 116 and executed by the processors 112. Additionally, or alternatively, the photography prohibitive area detection system can be implemented at least in part in hardware, such as an application-specific integrated circuit (ASIC), a field-programmable gate array (FPGA), an application-specific standard product (ASSP), a system-on-a-chip (SoC), a complex programmable logic device (CPLD), and so forth. This system is designed to identify environments where photography is restricted, utilizing advanced algorithms and sensor data to ensure compliance with privacy regulations and enhance user security

The photography prohibitive area detection system can be employed by the electronic device 100 for detecting environments where photography is restricted, using image data generated by the image capture device 101. The system is operable to identify such areas and perform operations as described herein in response to the detection of photography prohibitive environments.

To achieve this, in some embodiments the photography prohibitive area detection system employs at least one machine-learning model trained to recognize restricted area characteristics in image data. For example, a machine-learning model may process preview image frames generated by the electronic device 100 substantially in real-time (e.g., as the preview image frames are generated) to determine whether the frames depict a photography prohibitive environment.

As one example of processing preview image frames substantially in real-time, the photography prohibitive area detection system may acquire a first preview image frame and a second preview image frame sequentially using the image capture device 101. The first and second preview image frames may be acquired at a rate of thirty frames per second, as one non-limiting example (e.g., with approximately 0.03 seconds elapsing between acquisition of the first and second frames). One or more machine-learning models are operable to process the first preview image frame before the second frame is acquired (e.g., within the approximately 0.03-second duration between acquiring the frames). In some implementations, the rate of acquiring the preview image frames may be higher (e.g., sixty frames per second), and the machine-learning models are operable to process each frame before acquiring the next, even at such high rates.

To support such high speeds of processing, the machine-learning models can be trained specifically to detect restricted area characteristics while ignoring other features depicted by the frames. For example, the models may be trained using images depicting restricted areas without being trained on other types of images depicting unrelated subject matter (e.g., human faces).

As a result, the processing speed of the models can be much faster (e.g., twice as fast) compared to models trained to recognize other types of media. Additionally, the resulting size of the models may be much smaller (e.g., half the size) compared to models trained on other media types. While some systems employ remote machine-learning models accessible via a network (e.g., cloud-based models) for operations such as facial recognition, the reduced size of the models implementing the described techniques enables them to be stored locally within a memory of the electronic device 100. The local storage of the models can further increase the processing speed of the preview image frames to support the substantially real-time processing described above. However, the storage location of the models is non-limiting, and in some implementations, the models may be accessible over a network (e.g., via wired or wireless electronic communications between the electronic device 100 and remote systems implementing the models using cloud-based storage).

Embodiments of the disclosure contemplate that the electronic device 100 of FIG. 1 can operate in tandem with one or more companion electronic devices. Turning now to FIG. 2, illustrated therein is one explanatory system where the electronic device 100 is in operation with multiple companion electronic devices to monitor objects within a field of view of the image capture device 101.

FIG. 2 illustrates one explanatory system in which various mobile devices that in communication with each other. The system of FIG. 2 is operable to implement the described techniques for restricted or private area detection. In particular, a smartphone 200, a smart watch 203, the electronic device 100 of FIG. 1, and smart glasses 202 are shown. The various devices can be worn or otherwise fixed to a body of a user 108 in some instances. For example, the smart watch 203 is depicted fixed to a wrist of the user 108, the smart glasses 202 are depicted supported at a face of the user 108, and the electronic device 100 of FIG. 1 is depicted supported at a chest of the user 108 by a lanyard defined by the first strap (105) and second strap (106). Some devices, such as the smartphone 200, can be adjusted from being worn by the user 108 (e.g., stowed to a holster) to being held by the user, or vice versa.

The devices depicted by FIG. 2 are non-limiting example devices that can implement the photography restricted detection system. The depicted devices can include components that are similar to, or the same as, the components of the electronic device 100. For instance, the smartphone 200 can include the components such as the display, microphone, speaker, and so forth, that may be included in the electronic device 100. Moreover, each of the depicted devices can include an image sensor, such as the image capture device 101 of electronic device 100, which can be employed for acquiring the image sensor data 204 depicting objects within the environment 201 of the system. In one or more embodiments, this image sensor data 204 can then be processed by the restricted area detector (111) for generating the preview image data that can be analyzed using the artificial intelligence model (103) to generate restricted area classifications from the image sensor data 204.

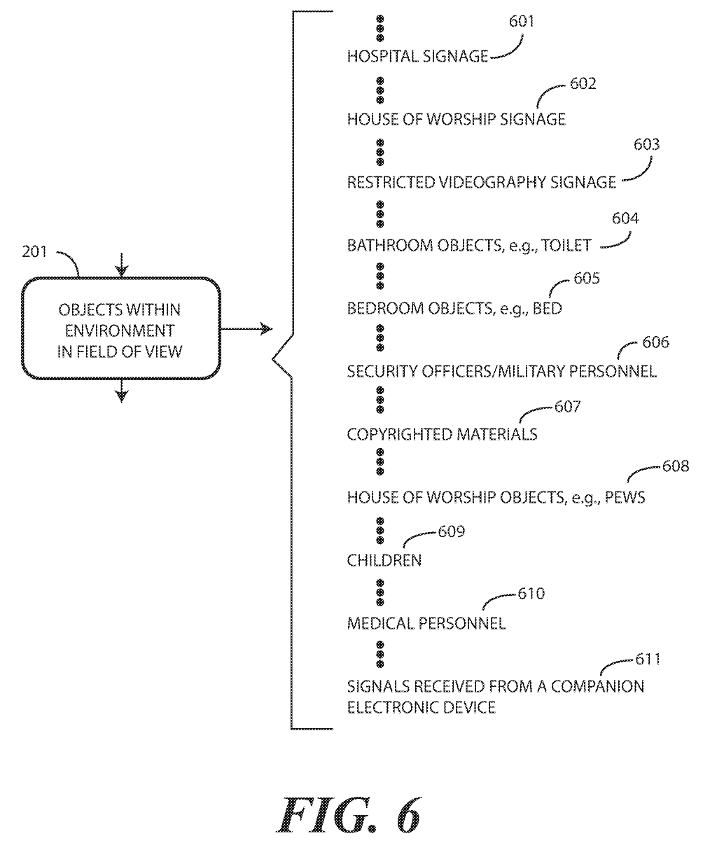

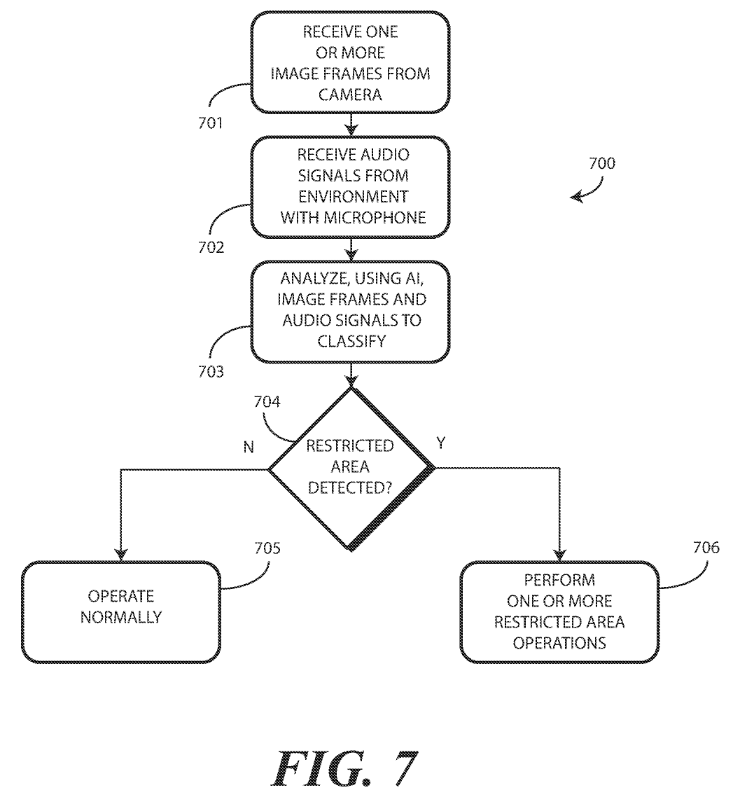

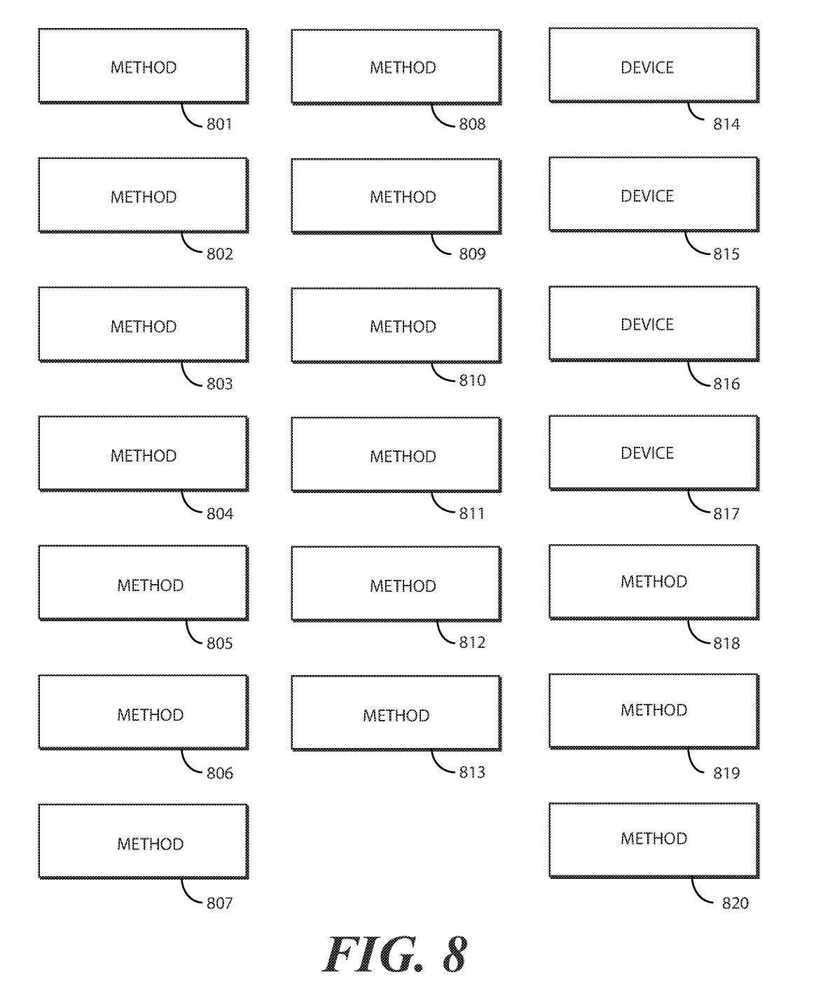

Restricted area classifications can be generated when the artificial intelligence model (103) finds items indicating that an environment is a photography prohibitive environment. Turning briefly to FIG. 6, illustrated therein are some examples of such items. Others will be obvious to those of ordinary skill in the art having the benefit of this disclosure.

Illustrated in FIG. 6 are various objects within an environment 201 that indicate a photography prohibitive environment. In this context, these objects are detected by the electronic device to ensure compliance with privacy and legal norms. In one or more embodiments, the photographic restrictions are signified by diverse environmental cues, including hospital signage 601, house of worship signage 602, restricted videography signage 603, bathroom objects 604, bedroom objects 605, security officers/military personnel 606, copyrighted materials 607, house of worship objects 608, children 609, and medical personnel 610.

Accordingly, hospital signage 601 serves as a clear indicator of a sensitive environment where privacy is of utmost importance. In such embodiments, in hospitals patient confidentiality is legally protected, and unauthorized photography can lead to breaches of privacy and legal repercussions. For example, capturing images in a hospital ward could inadvertently include patients undergoing treatment, thereby potentially violating privacy laws such as HIPAA in the United States. Moreover, in emergency rooms or operating theaters, photography could disrupt medical procedures or capture sensitive medical information, thus highlighting the need for caution.

In another embodiment, house of worship signage 602 signifies areas where photography may be restricted owing to religious customs and the need for reverence. For instance, in many religious settings the act of taking photographs is considered either disrespectful or intrusive. As an example, during a religious ceremony capturing images could disturb the solemnity of the event or infringe on the privacy of worshippers. In some cultures, photographing sacred objects or rituals is strictly prohibited, with such signage serving as a reminder of these cultural norms.

Furthermore, restricted videography signage 603 clearly indicates areas where recording is not allowed. Under these circumstances, such signage is frequently found in locations such as museums, theaters, or private events where intellectual property rights or privacy concerns are at stake. For example, in a museum, photography might be restricted to protect artworks from damage caused by flash photography, or to comply with copyright agreements. Similarly, at private events organizers may wish to control the distribution of images to maintain privacy or a specific atmosphere.

Subsequently, bathroom objects 604, such as toilets, are universally recognized as indicators of private spaces where photography is inappropriate. In this illustrative embodiment, bathrooms are intimate spaces, and capturing images therein constitutes a clear violation of personal privacy. For example, in public restrooms individuals expect a reasonable degree of privacy, and the presence of such objects 604 in the field of view prompts the device to cease recording to prevent any potential privacy breaches.

In a similar manner, bedroom objects 605, like beds, also denote private areas where photography is best avoided. In one or more embodiments, bedrooms are personal spaces where capturing images can infringe on an individual’s privacy. For instance, in a hotel room guests have an expectation of privacy, and unauthorized photography could lead to legal issues or even negatively impact the establishment’s reputation.

Moreover, security officers or military personnel 606 are often present in areas where photography is restricted for security reasons. In embodiments relating to government buildings, military bases, or secure facilities, capturing images may compromise security protocols or reveal sensitive information. The presence of security personnel frequently serves as an indication that photography is not permitted, prompting the device to disable recording capabilities.

Additionally, copyrighted materials 607, such as artworks or documents, are protected by intellectual property laws, and unauthorized photography can result in legal consequences. In embodiments where such materials are present in environments like art galleries or libraries, capturing images without permission may infringe on the rights of the creators or owners. As a result, the device is designed to recognize these materials and prevent recording to ensure compliance with copyright laws.

Furthermore, house of worship objects 608, such as pews or altars, further emphasize the requirement for discretion in religious settings. In these embodiments, such objects are naturally associated with sacred rituals or ceremonies and photographing them without appropriate permission can be interpreted as disrespectful. Accordingly, the device is expected to be sensitive to the presence of these objects and adjust its functionality to respect cultural and religious practices.

In addition, the presence of children 609 in an environment can indicate a need for heightened privacy considerations. Under ordinary conditions, capturing images of minors without consent is a particularly sensitive matter as this can lead to privacy violations or legal challenges. For example, in settings such as schools, playgrounds, or family events, the device is configured to recognize the presence of children 609 and to disable recording to protect their privacy.

Moreover, medical personnel 610 are typically found in environments where maintaining patient confidentiality is of great importance. In embodiments pertaining to hospitals or clinics, capturing images of medical staff might inadvertently include patients or sensitive medical information. As a result, the presence of medical personnel 610 can signal the device to cease recording to maintain compliance with privacy regulations and ensure that patient confidentiality is preserved.

Signals 611 received from a companion electronic device may also indicate a photography prohibitive environment. In one or more embodiments, these signals emanate from devices that are aware of local privacy policies or have detected restricted areas through their own sensors, such as restricted videography signage 603 and hospital signage 601. By receiving and processing these signals, the electronic device can further enhance situational awareness and ensure operation in accordance with prevailing privacy norms

Turning now back to FIG. 2, in some embodiments, the system of FIG. 2 includes smart glasses 202 as a companion electronic device that actively communicates with the communication device of electronic device 100, enabling the one or more processors of electronic device 100 to execute restricted area operations in response to receiving electronic communications from the smart glasses 202. This configuration is beneficial as it allows for enhanced situational awareness and privacy management by leveraging the additional sensory inputs and processing capabilities of the smart glasses.

For instance, in scenarios where the image capture device 101 of electronic device 100 may have limited visibility or is obstructed, the smart glasses can provide supplementary data to ensure accurate detection of restricted areas. Use cases where this approach is preferable include environments with complex layouts, such as museums or galleries, where the smart glasses can detect "No Photography" signs or restricted zones that may not be visible to the wearable device alone.

Additionally, in dynamic settings like airports or security checkpoints, the smart glasses can quickly relay information about restricted areas to the electronic device 100, allowing for timely execution of privacy-preserving operations without relying solely on the image capture device 101. This collaborative functionality between the smart glasses and electronic device 100 enhances the overall effectiveness of the system in maintaining compliance with privacy regulations and user security. Thus, in one or more embodiments the one or more processors of electronic device 100 are further configured to, in response to the communication device receiving an electronic communication from a companion electronic device indicating the photography prohibitive environment, to execute the one or more restricted area operations.

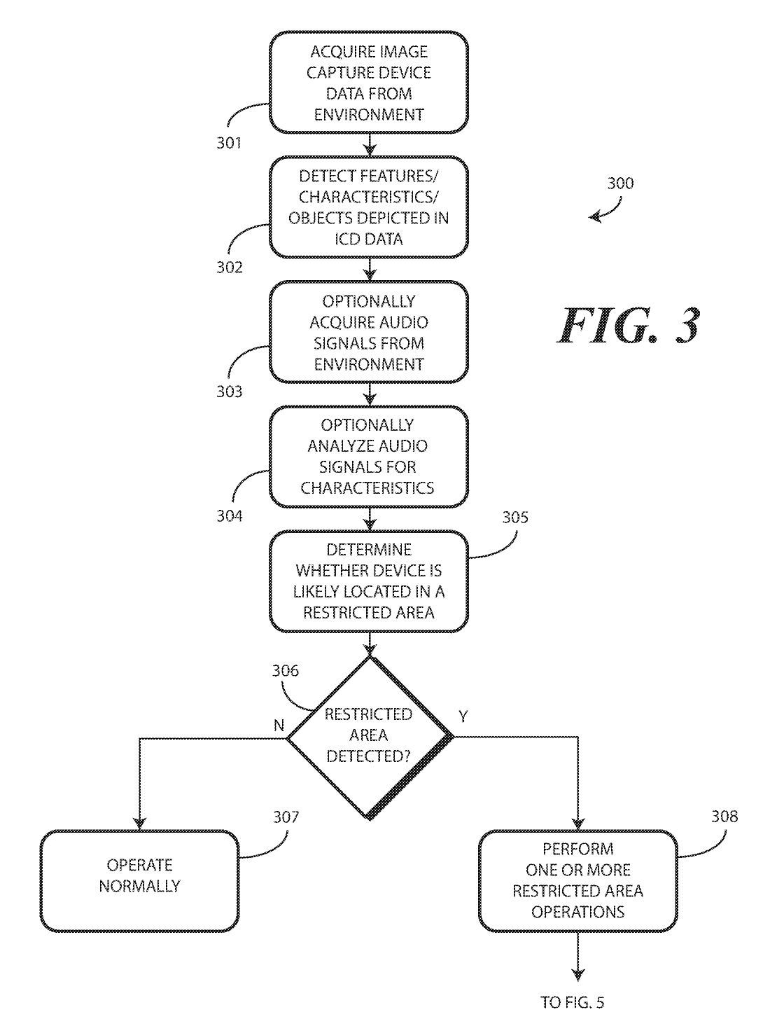

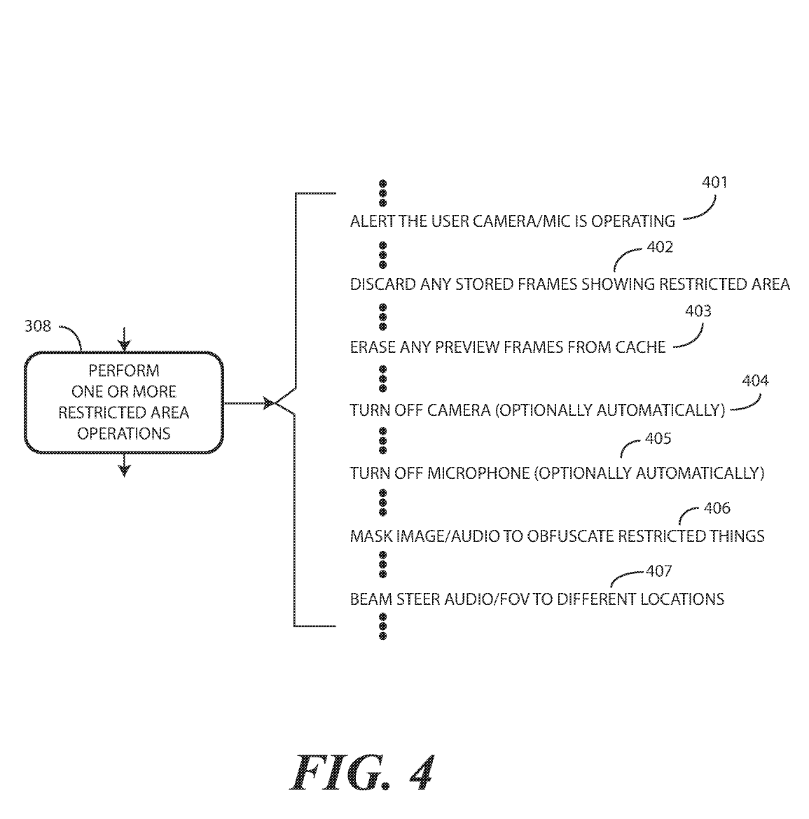

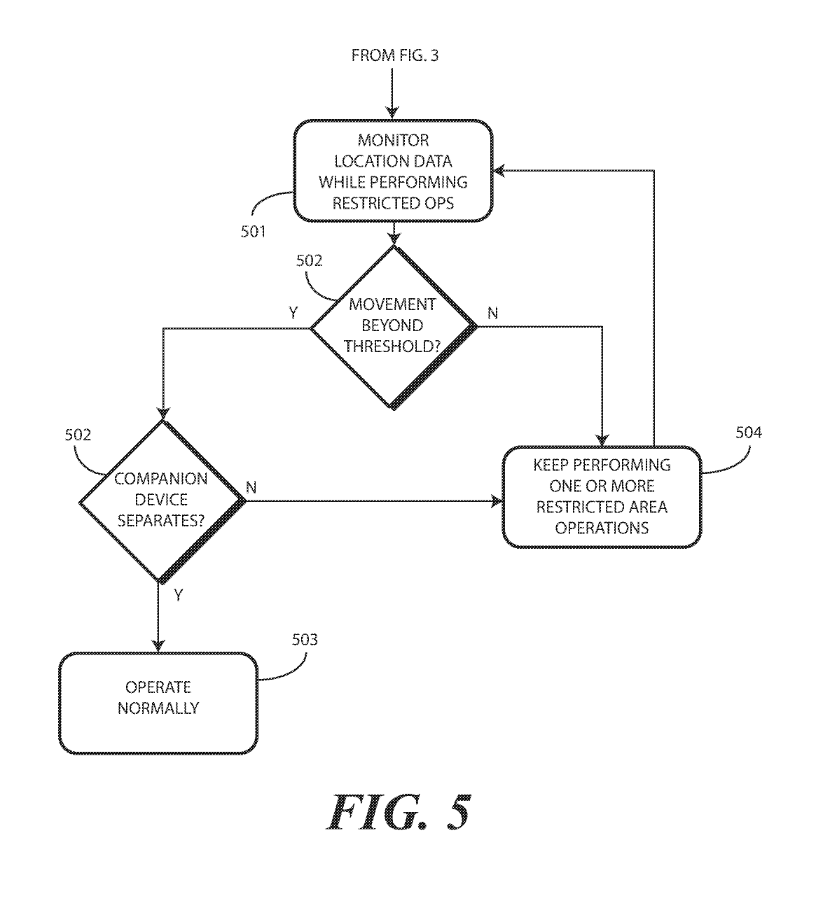

Turning now to FIG. 3, illustrated therein is one explanatory method 300 in accordance with one or more embodiments of the disclosure. Beginning at step 301, in one or more embodiments an image capture device captures image capture device from an environment of the electronic device. In one or more embodiments, step 301 comprises one or more processors of the electronic device carrying the image capture device receiving the image sensor data from the image capture device.

In one or more embodiments, step 302 comprises the one or more processors analyzing the image sensor data to identify restricted area characteristics depicted in the image sensor data. In one or more embodiments, the image sensor data captured by the electronic device may depict various restricted area characteristics that indicate environments where photography is prohibited. These characteristics can include visual indicators such as signage explicitly stating, "No Photography" or "Restricted Area," which are commonly found in locations like museums, theaters, and government facilities.

Additionally, the presence of specific objects or settings, such as medical equipment in hospitals, religious artifacts in places of worship, or security personnel in sensitive government areas, can serve as cues for restricted environments. The device may also recognize contextual elements like the interior of a courtroom or a private residence, where privacy is of great importance. Furthermore, the detection of children in environments such as schools or playgrounds can trigger privacy protocols to prevent unauthorized recording. By identifying these and other similar characteristics, the device ensures compliance with privacy regulations and enhances user security by automatically adjusting the device's recording capabilities in response to the detected environment

Optional step 303 can comprise receiving, by the one or more processors, audio sensor data from an audio capture device, with step 304 comprising the one or more processors analyzing the audio sensor data to identify other restricted area characteristics found within the audio sensor data. In one or more embodiments, the audio sensor data captured by the electronic device may reveal restricted area characteristics through specific auditory cues that indicate environments where recording is prohibited. These auditory cues can include sounds such as announcements or alarms that are typical in restricted environments like hospitals or government facilities.

For instance, the sound of medical equipment beeping or the distinct tone of a hospital intercom announcement can serve as indicators of a healthcare setting where privacy is of utmost importance. Similarly, the presence of religious hymns or chants can signify a place of worship, where discretion is often required.

Additionally, the sound of security alerts or the presence of military commands can indicate a government or military facility, where recording is typically restricted. By analyzing these and other similar audio characteristics, the device can enhance its ability to detect restricted areas, thereby ensuring compliance with privacy regulations and improving user security by automatically adjusting the device's recording capabilities in response to the detected environment.

Step 305, and corresponding decision 306, can comprise determining whether the electronic device is situated in a restricted area. In one or more embodiments, step 305 comprises analyzing the image sensor data and/or audio sensor data using an artificial intelligence model trained to classify restricted area characteristics indicative of a photography prohibited environment. In some embodiments, step 305 comprises analyzing, by the one or more processors using an on-device artificial intelligence model trained to classify restricted, private, or government-designated areas, one or more image frames and correlating analysis with the corresponding audio samples to generate a privacy classification determination.

Where the electronic device is not in a restricted area, the electronic device can operate normally at step 307. However, when the electronic device is in a restricted area, the one or more processors can perform one or more restricted area operations. These restricted area operations can vary. Turning now to FIG. 4, illustrated therein are a few explanatory restricted area operations. Others will be obvious to those of ordinary skill in the art having the benefit of this disclosure.

Illustrated in FIG. 4 are various operations that may be performed by an electronic device upon detection that the device is situated in a restricted area, as indicated by step 308. In this configuration, the operations are designed to ensure privacy and compliance with legal and social norms by managing the electronic device's data capture capabilities, including alerting 401 the user that the camera/microphone is operating, discarding 402 any stored frames showing restricted areas, erasing 403 any preview frames from cache, precluding 404 the capture of image sensor data by turning off the camera (optionally automatically), precluding 405 the capture of audio sensor data by turning off the microphone (optionally automatically), masking 406 image/audio to obfuscate restricted things, and beam steering 407 audio/field of view to different locations.

In one or more embodiments, the one or more restricted area operations comprise delivering an alert 401 indicating that the restricted area characteristics are depicted in the image sensor data. In one or more embodiments, the alert 401 comprises a call to action to disable the image capture device.

Accordingly, the first operation—alerting 401 the user that the camera or microphone is operating—serves as a notification mechanism. In this instance, the alert can be significant in scenarios wherein the user may remain unaware that the device is actively capturing data; for example, in a courtroom or during a confidential meeting, thereby prompting the user to take immediate action to prevent unauthorized recording.

In a subsequent embodiment, the one or more restricted area operations comprise deleting 402 the image sensor data depicting the restricted area characteristics from a memory of the electronic device. Embodiments of the disclosure can discard any stored frames showing restricted areas so as to ensure that any images or videos captured in sensitive environments, such as hospitals or private residences, are not retained in the device's memory. Thus, by consequence, this step 308 is particularly important in situations where accidental recording might otherwise lead to privacy breaches or legal issues.

Furthermore, erasing 403 any preview frames from the cache further enhances privacy by ensuring that temporary data stored during the device's operation is rendered inaccessible. As such, this operation holds importance in environments like government facilities, wherein even transient data could potentially contain sensitive information.

Turning next to the operations concerning the camera and microphone, examples of which comprise precluding 404 the capture of image sensor data by deactivating the image capture device and/or precluding 405 the capture of audio sensor data by deactivating the microphone, optionally in an automatic manner, provides a direct method to prevent data capture. In this regard, such operation is beneficial in places like museums or religious sites, where recording is often prohibited, and the automatic feature ensures that the device can respond swiftly to environmental cues without necessitating user intervention.

In one embodiment, masking 406 image or audio data to obfuscate restricted elements is employed as a sophisticated approach to privacy management. Said differently, in one or more embodiments the one or more restricted area operations comprise masking 406 portions of the image sensor data depicting the restricted area characteristics to obfuscate the restricted area characteristics. Accordingly, by blurring or altering specific parts of the captured data, the device continues to function while respecting privacy constraints, thereby proving useful in scenarios where complete data capture is not feasible, such as in public spaces that present mixed privacy requirements.

Beam steering the audio or field of view (FOV) to different locations 407 allows the device to adjust its focus away from sensitive areas. As a result, this operation is applicable in dynamic environments like airports or security checkpoints, where the device needs to adapt quickly to changing privacy requirements.

Thus, each of these steps 308 provides a distinct method to manage privacy concerns, ensuring that the device operates within the boundaries of legal and social expectations while effectively maintaining the device's functionality through alerting the user that the camera/mic is operating, discarding 402 any stored frames showing restricted area, erasing any preview frames from cache, optionally turning off the camera and the microphone, masking image/audio to obfuscate restricted things, and beaming steer audio/field of view to different locations. Again, this list of restricted area operations is illustrative only. Others will be obvious to those of ordinary skill in the art having the benefit of this disclosure.

As noted above, in some embodiments only image sensor data is analyzed to determine whether the restricted area operations should be performed. Illustrating by example, in some embodiments the analyzing utilizes an on-device artificial intelligence model trained to classify restricted, private, or government designated areas depicted within the image capture device to generate a restricted area classification designation.

However, in other embodiments the one or more processors can receive audio sensor data from an audio capture device, analyze the audio sensor data to identify other restricted area characteristics found within the audio sensor data, and responsive to identifying the other restricted area characteristics found within the audio sensor data, perform the one or more restricted area operations. It should be noted that in some embodiments, the performing the one or more restricted area operations occurs only in response to both the identifying the restricted area characteristics depicted in the image sensor data and the identifying the other restricted area characteristics found within the audio sensor data.

Once the restricted area operations have been performed, it can be important to know when to stop performing the same. Turning now to FIG. 5, illustrated therein are one or more method steps illustrating how this can occur. Others will be obvious to those of ordinary skill in the art having the benefit of this disclosure.

In one or more embodiments, step 501 involves the continuous observation of the electronic device's position relative to its surrounding environment. This step 501 plays a role in ensuring that the electronic device remains in compliance with privacy regulations by monitoring, via one or more sensors of the electronic device, the movement of the electronic device.

In some embodiments, the sensors used in this process may include GPS modules, accelerometers, or additional location-detecting technologies that provide real-time data regarding the device’s movement. Moreover, the system is further capable of monitoring, through one or more sensors and/or a communication device of the electronic device, the movement of a companion electronic device that is paired with the primary device. As a result, this dual monitoring capability ensures that both the primary and any associated devices are duly accounted for in terms of their spatial dynamics, which is important for maintaining privacy in sensitive environments.

In one or more embodiments, decision 502 represents an evaluation point in which the system determines whether the movement of the electronic device exceeds a predefined distance threshold. In one or more embodiments, this threshold is established as a predetermined value indicating a significant change in the device's location, suggesting that the device may have exited a restricted area. In such instances, the decision-making process involves analyzing the data collected from the sensors to determine if the movement indeed exceeds the threshold. If the system detects that the movement has surpassed this threshold, an inference is made that the device is likely no longer confined to a restricted zone, facilitating potential modifications in the operational state of the device.

Furthermore, in one or more embodiments, decision 503 involves assessing the relative distance between the primary electronic device and any paired companion devices. In some embodiments, this decision is important for ensuring that both devices remain within a permissible range of each other, thereby maintaining synchronized operations and adherence to privacy protocols. In this context, the system employs data from communication modules and sensors to calculate the separation distance, and as a result, determines whether the separation exceeds the predefined threshold, which, if so, signifies a considerable divergence in their respective locations.

In one or more embodiments, step 504 is executed upon satisfaction of the conditions established in either decision 502 or decision 503, thereby indicating that the device has exited a restricted area. In these embodiments, the processors are operative in re-enabling the image capture functionality of the device, thus allowing the device to resume its standard operational mode. As a result, the reactivation process is meticulously managed to ensure that reactivation occurs solely when the device is confirmed to be outside any privacy-sensitive zones, thereby maintaining strict compliance with pertinent privacy regulations.

In one or more embodiments, step 505, signifies the reversion of the device to its standard operational state. Under ordinary conditions, this step is reached once the device is determined to be situated outside of restricted areas, either as a result of movement beyond the threshold or due to separation from a companion device. Accordingly, the device then resumes its full spectrum of functionalities, including image capture and data processing, without the restrictions imposed in privacy-sensitive environments. Thus, the transition to normal operation is rendered seamless, ensuring an uninterrupted user experience while concurrently upholding essential privacy standards

Turning now to FIG. 7, illustrated therein is one explanatory method 700 in accordance with one or more embodiments of the disclosure. In one or more embodiments, the process begins with the acquisition of image capture device data from the environment, as indicated by step 701. Accordingly, the electronic device utilizes the image capture device to gather visual information from the surroundings. Under ordinary conditions, the image capture device is designed to operate continuously or in response to specific triggers, capturing image frames that are then processed by the device’s processors. The captured data serves as the primary input for subsequent analysis, enabling the device to assess the environment for restricted area characteristics. In some embodiments, the image capture device is further equipped with advanced imaging technology, such as high-resolution sensors and wide-angle lenses, to ensure comprehensive coverage of the environment.

Subsequently, step 703 involves detecting features, characteristics, or objects depicted in the image capture device data. In one or more embodiments, this detection process is facilitated by the device’s processors, which analyze the image frames to identify specific visual indicators that may signify a restricted area. Accordingly, the analysis leverages an on-device artificial intelligence model trained to recognize restricted, private, or government-designated areas. In some embodiments, the AI model is optimized for rapid processing, allowing the model to swiftly classify environments based on visual cues such as signage, objects, or spatial configurations. This step is important for determining whether the device is situated in a location where recording is prohibited.

In one or more embodiments, step 702 introduces the optional acquisition of audio signals from the environment. Under ordinary conditions, in addition to visual data, the electronic device is capable of capturing audio information through the microphone. In some embodiments, this capability enhances the device’s situational awareness by providing auditory context that may corroborate visual indicators of restricted areas. Accordingly, the audio signals are collected in real time and serve as supplementary data for the device’s processors to analyze. This integration of audio data is particularly beneficial in environments where visual cues alone may not suffice to accurately determine privacy-sensitive zones.

Once audio signals are acquired, step 703 can include optionally analyzing these signals for characteristics indicative of restricted areas. In some embodiments, the device’s processors employ the AI model to examine the audio data for specific sounds or patterns that may suggest the presence of a restricted environment. Under ordinary conditions, this analysis includes identifying auditory cues such as announcements, alarms, or ambient noises typical of sensitive locations like hospitals or government facilities. In one or more embodiments, by cross-referencing audio and visual data, the device can achieve an elevated level of confidence in the classification of restricted areas, thereby reducing the likelihood of false positives or negatives.

Step 703 is dedicated to determining whether the device is likely located in a restricted area. In one or more embodiments, this decision-making process is based on the analysis of both image and audio data, wherein the AI model generates a privacy classification determination. Accordingly, the processors assess the combined data to ascertain the presence of restricted area characteristics, such as "No Photography" signs or the sound of medical equipment. This determination plays a significant role in guiding the device’s subsequent actions, ensuring that the device's operation remains in compliance with applicable privacy regulations.

In this illustrative embodiment, decision 706 serves as a juncture in the process. In one or more embodiments, if the analysis indicates that the device is situated in a restricted area, the device proceeds to perform one or more restricted area operations, as outlined in step 706. Under ordinary conditions, these operations are designed to mitigate privacy risks by managing the device’s recording capabilities. Conversely, in some embodiments, if no restricted area is detected, the device continues to operate normally, as indicated by step 705. Thus, the bifurcation ensures that the device adapts its functionality based on the environmental context, maintaining user privacy while preserving operational efficiency.

Turning now to FIG. 8, illustrated therein are various embodiments of the disclosure. The embodiments of FIG. 8 are shown as labeled boxes in FIG. 8 due to the fact that the individual components of these embodiments have been illustrated in detail in FIGS. 1-7, which precede FIG. 8. Accordingly, since these items have previously been illustrated and described, their repeated illustration is no longer essential for a proper understanding of these embodiments. Thus, the embodiments are shown as labeled boxes.

At 801, a method in an electronic device comprises receiving, by one or more processors, image sensor data from an image capture device. At 801, the method comprises analyzing, by the one or more processors, the image sensor data to identify restricted area characteristics depicted in the image sensor data. At 801, responsive to identifying the restricted area characteristics depicted in the image sensor data, the method comprises performing one or more restricted area operations.

At 802, the one or more restricted area operations of 801 comprise delivering an alert indicating that the restricted area characteristics are depicted in the image sensor data. At 803, the alert of 803 comprises a call to action to disable the image capture device.

At 804, the one or more restricted area operations of 801 comprise deleting the image sensor data depicting the restricted area characteristics from a memory of the electronic device. At 805, the one or more restricted area operations of 801 comprise deactivating the image capture device.

At 806, the method of 801 further comprises, responsive to the performing the one or more restricted area operations, monitoring, using one or more sensors of the electronic device, movement of the electronic device. At 806, responsive to the movement of the electronic device exceeding a predefined distance threshold, the method comprises reactivating, by the one or more processors, the image capture device. At 807, the one or more restricted area operations of 801 comprise masking portions of the image sensor data depicting the restricted area characteristics to obfuscate the restricted area characteristics.

At 808, the method of 801 further comprises, responsive to the performing the one or more restricted area operations, monitoring, using one or more sensors and/or a communication device of the electronic device, movement of a companion electronic device that is paired with the electronic device. At 808, the method comprises, responsive to the separation between the electronic device and the companion electronic device exceeding a predefined distance threshold, reactivating, by the one or more processors, the image capture device.

At 809, the method of 801 further comprises receiving, by one or more processors, audio sensor data from an audio capture device. At 809, the method comprises analyzing, by the one or more processors, the audio sensor data to identify other restricted area characteristics found within the audio sensor data. At 809, responsive to identifying the other restricted area characteristics found within the audio sensor data, the method comprises performing the one or more restricted area operations.

At 810, the performing the one or more restricted area operations of 809 occurs only in response to both the identifying the restricted area characteristics depicted in the image sensor data and the identifying the other restricted area characteristics found within the audio sensor data. At 811, the analyzing of 801 utilizes an on-device artificial intelligence model trained to classify restricted, private, or government designated areas depicted within the image capture device to generate a restricted area classification designation.

At 812, an electronic device comprises an image capture device operable to capture image sensor data of an environment of the electronic device. At 812, the electronic device comprises one or more processors.

At 812, the one or more processors are configured to analyze the image sensor data using an artificial intelligence model trained to classify restricted area characteristics indicative of a photography prohibited environment. At 812, the one or more processors are configured to, in response to restricted area classifications from the image sensor data indicating the photography prohibitive environment, execute one or more restricted area operations.

At 813, the electronic device of 812 further comprises a memory defining a rolling buffer. At 813, the one or more restricted operations comprise controlling the rolling buffer to temporarily store and selectively discard image frames of the image sensor data depicting the restricted area characteristics.

At 814, the electronic device of 812 further comprises a communication device. At 814, the one or more processors are further configured to, in response to the communication device receiving an electronic communication from a companion electronic device indicating the photography prohibitive environment to execute the one or more restricted area operations.

At 815, the one or more restricted area operations of 812 comprise precluding the image capture device from capturing additional image sensor data. At 816, the electronic device of 815 further comprises a location detector 120. At 816, the one or more processors are further configured to cease the precluding in response to the location detector 120 determining a new location of the electronic device is beyond a previous location of the electronic device where the restricted area classifications occurred.

At 817, the electronic device of 812 further comprises an audio capture device operable to capture audio sensor data. At 817, the one or more processors are further configured to analyze the audio sensor data using the artificial intelligence model and, in response to other restricted area classifications from the audio sensor data indicating the photography prohibitive environment, execute the one or more restricted area operations.

At 818, a method in an electronic device comprises receiving, by one or more processors, one or more image frames and corresponding audio samples from the electronic device. At 818, the method comprises analyzing, by the one or more processors using an on-device artificial intelligence model trained to classify restricted, private, or government-designated areas, the one or more image frames.

At 818, the method comprises correlating analysis with the corresponding audio samples to generate a privacy classification determination. At 818, the method comprises discarding, by the one or more processors, a set of image frames from a rolling buffer in response to the privacy classification determination indicating a presence of a restricted or private area.

At 819, the method of 818 further comprises notifying, by the one or more processors, a user of detection of the restricted or private area via a user alert. At 820, the method of 818 further comprises ceasing, by the one or more processors, the discarding upon detecting a displacement of the electronic device from the restricted or private area.

In the foregoing specification, specific embodiments of the present disclosure have been described. However, one of ordinary skill in the art appreciates that various modifications and changes can be made without departing from the scope of the present disclosure as set forth in the claims below. Thus, while preferred embodiments of the disclosure have been illustrated and described, it is clear that the disclosure is not so limited. Numerous modifications, changes, variations, substitutions, and equivalents will occur to those skilled in the art without departing from the spirit and scope of the present disclosure as defined by the following claims.

For example, in one embodiment the electronic device comprises a compact, wearable form factor, such as a pin or badge, that can be easily attached to clothing or accessories, allowing for discreet and hands-free operation. The image capture device may be a miniaturized camera with a wide-angle lens, providing a broad field of view to effectively monitor the environment for restricted area characteristics. The one or more processors could be integrated into a low-power microcontroller, ensuring efficient processing of image data while maintaining battery life.

In another embodiment, the electronic device may include a detachable module that houses the image capture device and processors, enabling users to switch between different modules with varying camera specifications, such as resolution or field of view, to suit specific needs. The artificial intelligence model used for classification could be updated wirelessly, allowing the device to adapt to new privacy regulations or restricted area definitions. Additionally, the device may feature a customizable alert system, where users can select from various notification methods, such as vibrations, audible alerts, or visual indicators, to be informed of restricted area detections.

In yet another embodiment, the electronic device could be integrated into a larger system, such as a smart home or office environment, where the electronic device communicates with other devices to enhance privacy management across multiple platforms. This integration could involve using a shared network to synchronize restricted area classifications and operations, ensuring consistent privacy protection throughout the environment.

Accordingly, the specification and figures are to be regarded in an illustrative rather than a restrictive sense, and all such modifications are intended to be included within the scope of present disclosure. The benefits, advantages, solutions to problems, and any element(s) that may cause any benefit, advantage, or solution to occur or become more pronounced are not to be construed as a critical, required, or essential features or elements of any or all the claims.

What is claimed is:

1. A method in an electronic device, the method comprising:
receiving, by one or more processors, image sensor data from an image capture device,
analyzing, by the one or more processors, the image sensor data to identify restricted area characteristics depicted in the image sensor data; and
responsive to identifying the restricted area characteristics depicted in the image sensor data, performing one or more restricted area operations.

2. The method of claim 1, wherein the one or more restricted area operations comprise delivering an alert indicating that the restricted area characteristics are depicted in the image sensor data.

3. The method of claim 2, wherein the alert comprises a call to action to disable the image capture device.

4. The method of claim 1, wherein the one or more restricted area operations comprise deleting the image sensor data depicting the restricted area characteristics from a memory of the electronic device.

5. The method of claim 1, wherein the one or more restricted area operations comprise deactivating the image capture device.

6. The method of claim 1, further comprising, responsive to the performing the one or more restricted area operations:
monitoring, using one or more sensors of the electronic device, movement of the electronic device; and
responsive to the movement of the electronic device exceeding a predefined distance threshold, reactivating, by the one or more processors, the image capture device.

7. The method of claim 1, wherein the one or more restricted area operations comprise masking portions of the image sensor data depicting the restricted area characteristics to obfuscate the restricted area characteristics.

8. The method of claim 1, further comprising, responsive to the performing the one or more restricted area operations:
monitoring, using one or more sensors and/or a communication device of the electronic device, movement of a companion electronic device that is paired with the electronic device; and
responsive to separation between the electronic device and the companion electronic device exceeding a predefined distance threshold, reactivating, by the one or more processors, the image capture device.

9. The method of claim 1, further comprising:
receiving, by one or more processors, audio sensor data from an audio capture device,
analyzing, by the one or more processors, the audio sensor data to identify other restricted area characteristics found within the audio sensor data; and
responsive to identifying the other restricted area characteristics found within the audio sensor data, performing the one or more restricted area operations.

10. The method of claim 9, wherein the performing the one or more restricted area operations occurs only in response to both the identifying the restricted area characteristics depicted in the image sensor data and the identifying the other restricted area characteristics found within the audio sensor data.

11. The method of claim 1, wherein the analyzing utilizes an on-device artificial intelligence model trained to classify restricted, private, or government designated areas depicted within the image capture device to generate a restricted area classification designation.

12. An electronic device, comprising:
an image capture device operable to capture image sensor data of an environment of the electronic device; and
one or more processors;
wherein the one or more processors are configured to:
analyze the image sensor data using an artificial intelligence model trained to classify restricted area characteristics indicative of a photography prohibited environment; and
in response to restricted area classifications from the image sensor data indicating the photography prohibitive environment, execute one or more restricted area operations.

13. The electronic device of claim 12, further comprising a memory defining a rolling buffer, wherein the one or more restricted operations comprise controlling the rolling buffer to temporarily store and selectively discard image frames of the image sensor data depicting the restricted area characteristics.

14. The electronic device of claim 12, further comprising a communication device, wherein the one or more processors are further configured to, in response to the communication device receiving an electronic communication from a companion electronic device indicating the photography prohibitive environment to execute the one or more restricted area operations.

15. The electronic device of claim 12, wherein the one or more restricted area operations comprise precluding the image capture device from capturing additional image sensor data.

16. The electronic device of claim 15, further comprising a location detector 120, wherein the one or more processors are further configured to cease the precluding in response to the location detector 120 determining a new location of the electronic device is beyond a previous location of the electronic device where the restricted area classifications occurred.

17. The electronic device of claim 12, further comprising an audio capture device operable to capture audio sensor data, wherein the one or more processors are further configured to analyze the audio sensor data using the artificial intelligence model and, in response to other restricted area classifications from the audio sensor data indicating the photography prohibitive environment, execute the one or more restricted area operations.

18. A method in an electronic device, the method comprising:
receiving, by one or more processors, one or more image frames and corresponding audio samples from the electronic device;
analyzing, by the one or more processors using an on-device artificial intelligence model trained to classify restricted, private, or government-designated areas, the one or more image frames and correlating analysis with the corresponding audio samples to generate a privacy classification determination; and
discarding, by the one or more processors, a set of image frames from a rolling buffer in response to the privacy classification determination indicating a presence of a restricted or private area.

19. The method of claim 18, further comprising notifying, by the one or more processors, a user of detection of the restricted or private area via a user alert.

20. The method of claim 18, further comprising ceasing, by the one or more processors, the discarding upon detecting a displacement of the electronic device from the restricted or private area.
